(19) United States
(12) Patent Application Publication
(10) Pub. No.: US 2021/0198482 A1
(43) Pub. Date: Jul. 1, 2021

(54) POLYCARBONATE COMPOSITION COMPRISING PEARLESCENT PIGMENT AND/OR INTERFERENCE PIGMENT

(71) Applicant: COVESTRO INTELLECTUAL PROPERTY GMBH & CO. KG, Leverkusen (DE)

(72) Inventor: Derk Erich WANDNER, Odenthal (DE)

(73) Assignee: COVESTRO INTELLECTUAL PROPERTY GMBH & CO. KG, Leverkusen (DE)

(21) Appl. No.: 17/058,410

(22) PCT Filed: May 20, 2019
(86) PCT No.: PCT/EP2019/062965

§ 371 Date: Nov. 24, 2020

(30) Foreign Application Priority Data
May 25, 2018 (EP) 18174213.1

(51) Int. Cl. C08L 69/00; C08L 33/10; C08L 33/08; C08L 25/14; C08L 63/00; C09C 1/00

(52) U.S. Cl. CPC C08L 69/00; C08L 33/10; C08L 33/08; C08K 2003/2241; C08L 63/00; C09C 1/0021; C08L 25/14

(57) ABSTRACT

The invention relates to compositions based on aromatic polycarbonate which comprise metal oxide-coated micas as effect pigments and exhibit no significant molecular weight degradation of the polycarbonate, apparent from the MVR, under thermal stress. This is achieved by addition of small amounts of an epoxy-containing copolymer or terpolymer of styrene and acrylic acid and/or methacrylic acid in combination with a phosphite-containing thermal stabilizer.

The invention relates to thermoplastic polycarbonate compositions comprising interference and/or pearlescent pigment from the group of the metal oxide-coated micas, and to moldings made from these compositions.

Effect pigments are added to polycarbonate compositions in some cases in order to influence the appearance of the compositions by means of angle-dependent changes in hue and/or gloss. Effect pigments are platelet-shaped and bring about directed reflection and/or interference. There are various groups of effect pigments: Metal effect pigments, interference pigments and pearlescent pigments, although the boundaries particularly between the latter can be fluid and these are therefore also referred to collectively as “special effect pigments”.

Pearlescent pigments comprise transparent platelets having high refractive index. Multiple reflection gives rise to a pearl-like effect. Coloring in the case of interference pigments, which may be either transparent or opaque, is based primarily on interference.

The pearlescent and/or interference pigments especially also include metal oxide-coated mica pigments, which are employed in various sectors, for instance for housings of numerous domestic appliances or consumer electronics devices or as a design element in the architectural sector. Pearlescent effects and/or interference pigments of this kind are available inter alia under the “Magnapearl®” or “Mearlin®” names from BASF SE or under the “Iriodin®” or “Candurin®” names from Merck SE.

DE 20 19 325 A1 discloses pigmented aromatic polycarbonates having a content of approximately 5 to approximately 100 percent by weight of epoxy-containing copolymers, based on the pigment content.

WO 2016/096696 A1 describes a thermoplastic molding composition comprising g) 5 to 99.9 wt % of at least one thermoplastic polymer as component A; h) 0.05 to 10 wt % of at least one mica coated with a metal oxide as component B; i) 0.05 to 50 wt % of at least one flame retardant distinct from component B as component C; j) 0 to 35 wt % of at least one functional polymer distinct from component A as component D; k) 0 to 60 wt % of glass fibers as component E and 1) 0 to 10 wt % of further auxiliaries as component F, wherein the total amount of components A to E is 100 wt %.

EP 0 158 931 A1 relates to thermoplastic molding compositions comprising: A) 10 to 80 parts by weight of an aromatic, thermoplastic polycarbonate, B) 10 to 60 parts by weight of a graft polymer of ethylenically unsaturated monomers on rubbers with a rubber content of 5 to 80 wt %, based on the weight of component B) and C), 10 to 60 parts by weight of a thermoplastic, resinous, high molecular weight, rubber-free copolymer, wherein the sum of the parts by weight A+B+C is in each case 100, and optionally D) 1 to 20 parts by weight, based in each case on the sum of the parts by weight A+B+C+D, which is in turn 100 in each case, of an at least partially crosslinked butadiene-acrylonitrile copolymer rubber which comprises acrylonitrile to butadiene in a weight ratio of 15:85 to 35:65 as polymerized units and which has a particle size of 0.05 μm to 0.3 nm. Component C comprises 0.05 to 5 wt %, based on the total weight of component C, of an ethylenically unsaturated epoxy compound as copolymerized units.

EP 0 718 354 A2 discloses thermoplastic, aromatic polycarbonates comprising phosphine stabilizers. Example of employable phosphines are tris(4-diphenyl)phosphine or tris(α-naphthyl)phosphine.

When used in polycarbonate compositions, pearlescent pigments or interference pigments from the group of the metal oxide-coated micas typically lead to significant degradation of the polycarbonate, which is manifested in a reduction in the molecular weight and an associated reduction in the viscosity and hence increase in the melt volume flow rate MVR and deterioration in the mechanical properties. The degradation processes also lead to discoloration of the material.

In the compositions available on the market, the degradation processes are taken into account in that the polycarbonate is used with higher molecular weight than required for the actual application. The target molecular weight is then attained via the compounding and injection molding or extrusion processes at elevated temperature. Further parameters in the compounding process, such as the control of the energy input or the arrangement of the metering point for the effect pigment, also have a significant effect on the molecular weight of the polycarbonate that ultimately arises. However, it is found here that targeted control of the molecular weight is problematic.

An option in principle for minimizing the degradation of polycarbonate is the use of thermal stabilizers. For thermal stabilization of polycarbonate, it is customary to add essentially suitable organic phosphorus compounds such as aromatic phosphines, aromatic phosphites and organic antioxidants, especially sterically hindered phenols. There are frequent descriptions of the use of phosphites in combination with sterically hindered phenols, for instance in EP 0 426 499 A1. However, in the case of the effect pigments described, stabilization by phosphites only is insufficient.

The problem addressed by the present invention is accordingly that of providing polycarbonate compositions which comprise pearlescent and/or interference pigments from the group of metal oxide-coated micas and exhibit the lowest possible degradation of the polycarbonate during compounding so that the abovementioned disadvantages are avoided to the greatest possible extent.

It has surprisingly been found that the problem is solved by addition of an epoxy-containing copolymer or terpolymer of styrene and acrylic acid and/or methacrylic acid in combination with a phosphite thermal stabilizer to a polycarbonate composition comprising pearlescent and/or interference pigment(s) from the group of metal oxide-coated micas.

Thermoplastic compositions according to the invention are therefore those comprising
A) 50 wt % to 98.5 wt % of aromatic polycarbonate, and
B) 0.8 wt % to ≤5.0 wt % of interference pigment and/or pearlescent pigment from the group of the metal oxide-coated micas,
characterized in that the composition additionally comprises
C) 0.05 wt % to ≤3 wt % of an epoxy-containing copolymer or terpolymer of styrene and acrylic acid and/or methacrylic acid and
D) 0.001 wt % to 0.500 wt % of one or more thermal stabilizers, wherein component D comprises one or more phosphites as thermal stabilizers,
   and preferably thermoplastic compositions additionally comprising
E) further additives, more preferably 0 to 10 wt %, particularly preferably selected from the group consisting of flame retardants, anti-drip agents, impact modifiers, fillers, antistats, colorants, including pigments distinct from component B, also comprising carbon black, lubricants and/or demolding agents, hydrolysis stabilizers, compatibilizers, UV absorbers and/or IR absorbers.

Component A

Component A comprises aromatic polycarbonate. According to the invention, “polycarbonate” is understood to mean both homopolycarbonates and copolycarbonates. These polycarbonates may be linear or branched in the familiar manner. Also employable according to the invention are mixtures of polycarbonates.

A portion of up to 80 mol %, preferably of 20 mol % to 50 mol %, of the carbonate groups in the polycarbonates used according to the invention may be replaced by aromatic dicarboxylic ester groups. Polycarbonates of this type that incorporate not only acid radicals derived from carbonic acid but also acid radicals derived from aromatic dicarboxylic acids in the molecular chain are referred to as aromatic polyester carbonates. In the context of the present invention they are subsumed by the umbrella term “thermoplastic aromatic polycarbonates”.

Replacement of the carbonate groups by the aromatic dicarboxylic ester groups is in essence stoichiometric, and also quantitative, and the molar ratio of the reactants is therefore also maintained in the finished polyester carbonate. The aromatic dicarboxylic ester groups can be incorporated either randomly or blockwise.

The thermoplastic polycarbonates, including the thermoplastic aromatic polycarbonates, have average molecular weights M_{w}, determined by means of gel permeation chromatography according to DIN 55672-1:2007-08, calibrated against bisphenol A polycarbonate standards using dichloromethane as eluent, of 10 000 g/mol to 35 000 g/mol, preferably of 12 000 g/mol to 32 000 g/mol, more preferably of 15 000 g/mol to 32 000 g/mol, especially of 20 000 g/mol to 31 500 g/mol, calibration with linear polycarbonates (formed from bisphenol A and phosgene) of known molar mass distribution from PSS Polymer Standards Service GmbH, Germany, and calibration according to method 2301-0257502-09D (2009 edition in German language) from Currenta GmbH & Co. OHG, Leverkusen. The eluent is dichloromethane. Column combination of crosslinked styrene-divinylbenzene resins. Diameter of analytical columns: 7 5 mm; length: 300 mm. Particle sizes of column material: 3 μm to 20 μm. Concentration of solutions: 0.2 wt %. Flow rate: 1.0 ml/min, temperature of solutions: 30° C. Detection using a refractive index (RI) detector.

Details of the production of polycarbonates have been set out in many patent specifications during the last approximately 40 years. Reference may be made here for example to Schnell, “Chemistry and Physics of Polycarbonates”, Polymer Reviews, Volume 9, Interscience Publishers, New York, London, Sydney 1964, to D. Freitag, U. Grigo, P. R. Müller, H. Nouvertné, BAYER AG, “Polycarbonates” in Encyclopedia of Polymer Science and Engineering, Volume 11, Second Edition, 1988, pages 648-718, and finally to U. Grigo, K. Kirchner and P. R. Müller “Polycarbonate” in Becker/Braun, Kunststoff-Handbuch, Volume 3/1, Polycarbonate, Polyacetale, Polyester, Celluloseester, Carl Hanser Verlag Munich, Vienna 1992, pages 117-299.

Preferred modes of production of the polycarbonates to be used according to the invention, including the polyestercarbonates, are the known interfacial process and the known melt transesterification process (cf. e.g. WO 2004/063249 A1, WO 2001/05866 A1, U.S. Pat. Nos. 5,340,905 A, 5,097,002 A, 5,717,057 A).

The production of aromatic polycarbonates is effected for example by reaction of dihydroxyaryl compounds with carbonic halides, preferably phosgene, and/or with aromatic dicarboxyl dihalides, preferably benzenedicarboxyl dihalides, by the interfacial process, optionally using chain terminators and optionally using trifunctional or more than trifunctional branching agents, production of the polyester carbonates being achieved by replacing a portion of the carbonic acid derivatives with aromatic dicarboxylic acids or derivatives of the dicarboxylic acids, specifically with aromatic dicarboxylic ester structural units according to the proportion of carbonate structural units to be replaced in the aromatic polycarbonates. Production via a melt polymerization process by reaction of dihydroxyaryl compounds with, for example, diphenyl carbonate is likewise possible.

Dihydroxyaryl compounds suitable for producing polycarbonates are those of formula (1)

HO—Z—OH (1),

in which
Z is an aromatic radical which has 6 to 30 carbon atoms and may comprise one or more aromatic rings, may be substituted and may comprise aliphatic or cycloaliphatic radicals or alkylaryls or heteroatoms as bridging elements.

It is preferable when Z in formula (1) represents a radical of formula (2)

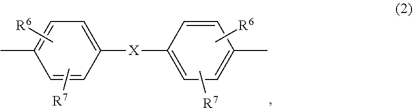

in which
R⁶ and R⁷ independently of one another are H, C₁- to C₁₈-alkyl, C₁- to C₁₈-alkoxy, halogen such as Cl or Br or in each case optionally substituted aryl- or aralkyl, preferably H or C₁- to C₁₂-alkyl, particularly preferably H or C₁- to C₈-alkyl and very particularly preferably H or methyl, and
X is a single bond, —SO₂—, —CO—, —O—, —S—, C₁- to C₆-alkylene, C₂- to C₅-alkylidene or C₅- to C₆-cycloalkylidene which may be substituted by C₁- to C₆-alkyl, preferably methyl or ethyl, or else C₆- to C₁₂-arylene which may optionally be fused to further aromatic rings comprising heteroatoms.

Preferably, X is a single bond, C₁- to C₅-alkylene, C₂- to C₅-alkylidene, C₅- to C₆-cycloalkylidene, —O—, —SO—, —CO—, —S—, —SO₂—

or is a radical of the formula (2a)

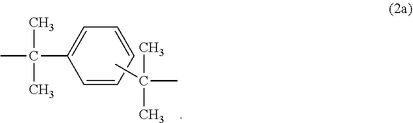

Dihydroxyaryl compounds suitable for the production of polycarbonates are for example hydroquinone, resorcinol, dihydroxydiphenyls, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes, phthalimidines derived from derivatives of isatin or phenolphthalein and the ring-alkylated, ring-arylated and ring-halogenated compounds thereof.

Preferred dihydroxyaryl compounds are 4,4′-dihydroxydiphenyl, 2,2-bis(4-hydroxyphenyl)propane (bisphenol A), 2,4-bis(4-hydroxyphenyl)-2-methylbutane, 1,1-bis(4-hydroxyphenyl)-p-diisopropylbenzene, 2,2-bis(3-methyl-4-hydroxyphenyl)propane, dimethylbisphenol A, bis(3,5-dimethyl-4-hydroxyphenyl)methane, 2,2-bis(3,5-dimethyl-4-hydroxyphenyl)propane, bis(3,5-dimethyl-4-hydroxyphenyl)sulfone, 2,4-bis(3,5-dimethyl-4-hydroxyphenyl)-2-methylbutane, 1,1-bis(3,5-dimethyl-4-hydroxyphenyl)-p-diisopropylbenzene and 1,1-bis(4-hydroxyphenyl)-3,3,5-trimethylcyclohexane and also the bisphenols (I) to (III)

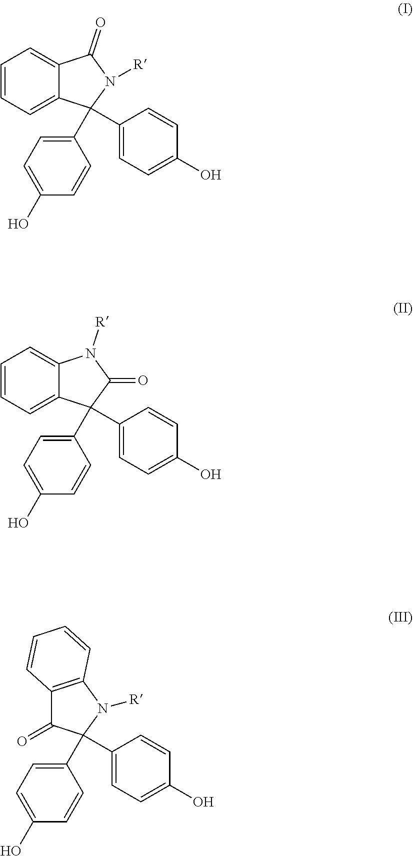

in which R′ in each case is C₁- to C₄-alkyl, aralkyl or aryl, preferably methyl or phenyl, most preferably methyl.

Particularly preferred dihydroxyaryl compounds are 2,2-bis(4-hydroxyphenyl)propane (bisphenol A), 2,2-bis(3,5-dimethyl-4-hydroxyphenyl)propane, 1,1-bis(4-hydroxyphenyl)cyclohexane, 1,1-bis(4-hydroxyphenyl)-3,3,5-trimethylcyclohexane and dimethylbisphenol A and also the diphenols of formulae (I), (II) and (III).

These and other suitable dihydroxyaryl compounds are described for example in U.S. Pat. Nos. 3,028,635, 2,999,825, 3,148,172, 2,991,273, 3,271,367, 4,982,014 and 2,999,846, in DE-A 1 570 703, DE-A 2063 050, DE-A 2 036 052, DE-A 2 211 956 and DE-A 3 832 396, in FR-A 1 561 518, in the monograph “H. Schnell, Chemistry and Physics of Polycarbonates, Interscience Publishers, New York 1964” and also in JP-A 62039/1986, JP-A 62040/1986 and JP-A 105550/1986.

In the case of homopolycarbonates only one dihydroxyaryl compound is used; in the case of copolycarbonates two or more dihydroxyaryl compounds are used. The dihydroxyaryl compounds employed, similarly to all other chemicals and assistants added to the synthesis, may be contaminated with the contaminants from their own synthesis, handling and storage. However, it is desirable to use raw materials of the highest possible purity.

Examples of suitable carbonic acid derivatives include phosgene or diphenyl carbonate.

Suitable chain terminators that may be used in the preparation of the polycarbonates are monophenols. Suitable monophenols are for example phenol itself, alkylphenols such as cresols, p-tert-butylphenol, cumylphenol and mixtures thereof.

Preferred chain terminators are phenols which are mono or polysubstituted with linear or branched, preferably unsubstituted C₁ to C₃₀ alkyl radicals or with tert-butyl. Particularly preferred chain terminators are phenol, cumylphenol and/or p-tert-butylphenol.

The amount of chain terminator to be employed is preferably 0.1 to 5 mol % based on moles of diphenols employed in each case. The chain terminators can be added before, during or after the reaction with a carbonic acid derivative.

Suitable branching agents are the trifunctional or more than trifunctional compounds known in polycarbonate chemistry, in particular those having three or more than three phenolic OH groups.

Suitable branching agents are for example 1,3,5-tri(4-hydroxyphenyl)benzene, 1,1,1-tri(4-hydroxyphenyl)ethane, tri(4-hydroxyphenyl)phenylmethane, 2,4-bis(4-hydroxyphenylisopropyl)phenol, 2,6-bis(2-hydroxy-5′-methylbenzyl)-4-methylphenol, 2-(4-hydroxyphenyl)-2-(2,4-dihydroxyphenyl)propane, tetra(4-hydroxyphenyl)methane, tetra(4-(4-hydroxyphenylisopropyl)phenoxy)methane and 1,4-bis((4′,4″-dihydroxytriphenyl)methyl)benzene and 3,3-bis(3-methyl-4-hydroxyphenyl)-2-oxo-2,3-dihydroindole.

The amount of the branching agents for optional employment is preferably 0.05 mol % to 2.00 mol %, based on moles of dihydroxyaryl compounds used in each case.

The branching agents may be either initially charged together with the dihydroxyaryl compounds and the chain terminators in the aqueous alkaline phase or added dissolved in an organic solvent before the phosgenation. In the case of the transesterification process the branching agents are employed together with the dihydroxyaryl compounds.

Particularly preferred polycarbonates are the homopolycarbonate based on bisphenol A, the homopolycarbonate based on 1,3-bis(4-hydroxyphenyl)-3,3,5-trimethylcyclohexane and the copolycarbonates based on the two monomers bisphenol A and 1,1-bis(4-hydroxyphenyl)-3,3,5-trimethylcyclohexane, and also homo- or copolycarbonates derived from the diphenols of formulae (I), (II) and/or (III)

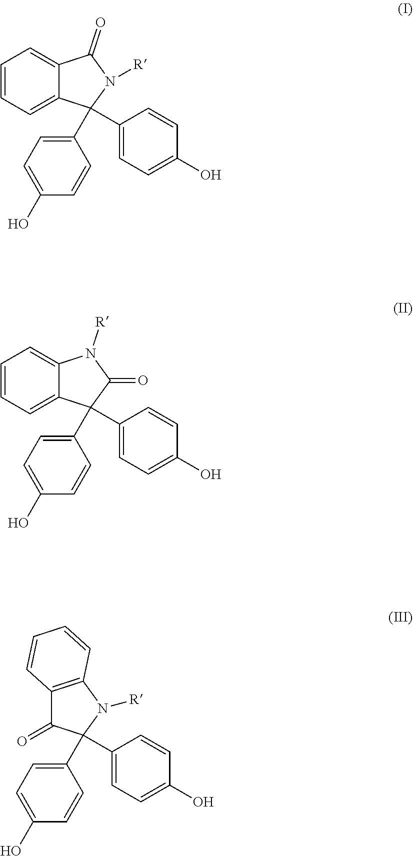

in which R′ in each case represents C₁- to C₄-alkyl, aralkyl or aryl, preferably methyl or phenyl, very particularly preferably methyl, particularly bisphenol A.

To achieve incorporation of additives, component A is preferably used at least partly in the form of powders, pellets or mixtures of powders and pellets.

The polycarbonate preferably has an MVR of 5 to 20 cm³/(10 min), more preferably of 5.5 to 12 cm³/(10 min), yet more preferably up to 8 cm³/(10 min), determined according to ISO 1133:2012-03 at a testing temperature of 300° C. with a load of 1.2 kg.

The polycarbonate employed may also be a mixture of different polycarbonates, for example of polycarbonates A1 and A2:

It is preferable when the amount of the aromatic polycarbonate A1 based on the total amount of polycarbonate is 25.0 to 85.0 wt %, preferably 28.0 to 84.0 wt %, more preferably 30.0 to 83.0 wt %, wherein this aromatic polycarbonate is based on bisphenol A and preferably has a melt volume flow rate MVR of 5 to 15 cm³/10 min, more preferably a melt volume flow rate MVR of 6 to 12 cm³/10 min, determined according to ISO 1133 (test temperature 300° C., mass 1.2 kg, DIN EN ISO 1133-1:2012-03).

It is preferable when the amount of the pulverulent aromatic polycarbonate A2 based on the total amount of polycarbonate is 2.0 to 12.0 wt %, preferably 3.0 to 11.0 wt %, particularly preferably 4.0 to 10.0 wt %, very particularly preferably from 5.0 to 8.0 wt %, wherein this aromatic polycarbonate is preferably based on bisphenol A and has a preferred melt volume flow rate MVR of 12 to 65 cm³/(10 min), more preferably a melt volume flow rate MVR of 14 to 32 cm³/(10 min), and particularly preferably a melt volume flow rate MVR of 15 to 20 cm³/(10 min).

Compositions according to the invention altogether employ 50 to 98.5 wt %, preferably 80 to 98.0 wt %, more preferably 85 to 97.5 wt %, particularly preferably 90.0 to 97.5 wt %, very particularly preferably 93.0 wt % to 97.5 wt %, of aromatic polycarbonate.

Component B

Component B of the compositions according to the invention comprises interference pigments and/or pearlescent pigments from the group of the metal oxide-coated micas. The mica may be naturally occurring or synthetically produced mica, the latter being preferable owing to its typically higher purity. Mica which is obtained from nature is typically accompanied by further minerals. In the case of mica obtained from nature, the reported amount of component B “mica” also includes relevant impurities. The mica is preferably muscovite-based, i.e. it preferably comprises at least 60 wt %, more preferably at least 70 wt %, yet more preferably at least 85 wt %, particularly preferably at least 90 wt %, of muscovite, based on the total weight of the mica proportion—without metal oxide-coating—in the interference and/or pearlescent pigment.

The metal oxide coating preferably comprises one or more coating layers comprising titanium dioxide, tin oxide, aluminum oxide and/or iron oxide, wherein the metal oxide is more preferably iron(III) oxide (Fe₂O₃), iron(II, III) oxide (Fe₃O₄, a mixture of Fe₂O₃ and FeO) and/or titanium dioxide, particularly preferably titanium dioxide. It is very particularly preferable when component B is a titanium dioxide-coated mica.

The proportion of the titanium dioxide in the total weight of the pigment is preferably 30 to 60 wt %, yet more preferably 35 to 55 wt %, and the proportion of the mica is preferably 40 to 70 wt %, yet more preferably 45 to 65 wt %.

Preferred titanium dioxides are rutile and/or anatase. It is particularly preferable when the pigment comprises anatase-coated mica; it is very particularly preferable when at least 90 wt %, preferably 95 wt %, more preferably at least 98 wt %, of pigment component B is anatase-coated mica.

To increase compatibility with the polymer matrix composed of polycarbonate, the pigment preferably also has a silicate and/or silicon dioxide coating, especially a sol-gel coating. This typically also increases the weathering resistance and chemical stability of the pigment.

The median particle size (D50) of the pigment, determined by laser diffractometry on an aqueous slurry of the pigment, is preferably 1 to 100 μm, more preferably 5 to 80 μm for synthetic mica and more preferably 3 to 30 μm for natural mica, generally for mica particularly preferably 3.5 to 15 μm, very particularly preferably 4.0 to 10 μm, most preferably 4.5 to 8.0 μm, The D90, likewise determined by laser diffractometry on an aqueous slurry of the pigment, is preferably 10 to 150 μm for synthetic mica and preferably 5 to 80 μm for natural mica. The density of the pigment is preferably 2.5 to 5.0 g/cm³, more preferably 2.8 to 4.0 g/cm³, determined according to DIN EN ISO 1183-1:2013-04.

The proportion of the at least one metal oxide-coated mica in the overall polycarbonate-based composition is 0.8 wt % to ≤5.0 wt %, preferably 1.0 to ≤3.0 wt %, more preferably 1.2 wt % to 2.5 wt %, particularly preferably 1.5 wt % to 2.0 wt %.

Component C

Component of the compositions according to the invention is an epoxy-containing copolymer or terpolymer of styrene and acrylic acid and/or methacrylic acid. The epoxy groups may be introduced via unsaturated epoxides which are incorporated as copolymerized units. Such an unsaturated epoxide may be an acrylate or methacrylate which bears an epoxy group in the molecule portion formally derived from an alcohol, for example glycidyl (meth)acrylate. Component C preferably comprises a copolymer of styrene and 2,3-epoxypropyl methacrylate, particularly preferably is a copolymer of styrene and 2,3-epoxypropyl methacrylate.

The copolymer/terpolymer of component C, in particular the copolymer of styrene and 2,3-epoxypropyl methacrylate, preferably has a styrene content, determined by ¹H-NMR spectroscopy in CDCl₃, of 30 to 70 wt %, more preferably 40 to 60 wt %, particularly preferably of 50 to 55 wt %.

The weight-average molar mass of the copolymer or terpolymer of component C, in particular of the copolymer of styrene and 2,3-epoxypropyl methacrylate, determined by gel permeation chromatography in o-dichlorobenzene at 150° C. using polystyrene standards, is preferably 2000 to 25000 g/mol, more preferably 3000 to 15000 g/mol, yet more preferably 5000 to 10000 g/mol, particularly preferably 6000 to 8000 g/mol.

The epoxy proportion of the polymer of component C is preferably 5 to 20 wt %, more preferably 7 to 18 wt %, particularly preferably 10 to 15 wt %, determined according to DIN EN 1877-1:2000.

Such polymers are for example marketed by BASF SE under the Joncryl® ADR brand.

The amount of component C in the overall composition is 0.05 wt % to ≤3 wt %, preferably 0.1 wt % to 2.0 wt %, more preferably 0.12 wt % to 1.5 wt %, particularly preferably 0.15 wt % to ≤1 wt %, especially up to ≤0.5 wt %.

Component D

The compositions according to the invention comprise 0.001 to 0.500 wt %, preferably 0.005 to 0.300 wt %, more preferably 0.05 wt % to 0.270 wt %, yet more preferably 0.15 to 0.25 wt %, particularly preferably 0.08 to 0.18 wt %, of one or more thermal stabilizers, wherein component D comprises one or more phosphites as thermal stabilizers.

Stabilizers based on phosphine, based on phosphonite (in particular based on diphosphonite), based on phosphonate, from the group of phenolic antioxidants or a mixture of at least two of the abovementioned compounds may additionally be present.

Phosphites in the context of the present invention are understood to mean esters of phosphonic acid (often also referred to as phosphorous esters) having the general structure P(OR)₃ where R represents aliphatic and/or aromatic hydrocarbyl radicals, where the aromatic hydrocarbyl radicals may have further substituents, for example alkyl groups, in branched and/or unbranched form.

Phosphonates are understood to mean compounds derived from the basic structure R—PO(OH)₂ where R represents aliphatic and/or aromatic hydrocarbyl radicals, where the aromatic hydrocarbyl radicals may have further substituents, for example branched and/or unbranched alkyl groups. The OH groups of the basic structure may have been partly or fully esterified to give OR functionalities where R in turn represents aliphatic and/or aromatic hydrocarbyl radicals, where the aromatic hydrocarbyl radicals may have further substituents, for example alkyl groups, in branched and/or unbranched form, or may have been partly or fully deprotonated, where the negative overall charge is balanced by a corresponding counterion.

Phosphonites in the context of the present invention are understood to mean esters, especially diesters, of phosphonous acid of the R—P(OR)₂ type where R represents aliphatic and/or aromatic hydrocarbyl radicals, where the aromatic hydrocarbyl radicals may have further substituents, for example alkyl groups, in branched and/or unbranched form. The phosphonites here may have one phosphorus atom or else multiple phosphorus atoms bridged via corresponding aliphatic and/or aromatic hydrocarbons.

The R radicals in one compound may be the same or different in each case.

There are no restrictions with regard to the selection of the phosphines, the phosphine compounds preferably being selected from the group comprising aliphatic phosphines, aromatic phosphines and aliphatic-aromatic phosphines.

The phosphine compounds may be primary, secondary and tertiary phosphines. Particular preference is given to using tertiary phosphines, particular preference being given to aromatic phosphines and very particular preference to tertiary aromatic phosphines.

Preference is given to using triphenylphosphine (TPP), trialkylphenylphosphine, bisdiphenylphosphinoethane or a trinaphthylphosphine, among which very particular preference is given to triphenylphosphine (TPP), or mixtures of these phosphines.

It is in principle possible to use mixtures of different phosphines.

The production and properties of phosphine compounds are known to those skilled in the art and described for example in EP 0 718 354 A2 and “Ullmann Enzyklopadie der Technischen Chemie”, 4th Ed., Vol. 18, pp. 378-398 and Kirk-Othmer, 3rd Ed., Vol. 17, pp. 527-534.

In respect of the use amount of the phosphine compound in the stabilizer mixture, it should be taken into account that the substance can be oxidized under particular processing conditions depending on temperature and residence time. The oxidized fraction is no longer available for stabilization. Therefore, the number of processing steps and the respective processing conditions should be taken into account. After thermal processing, the composition thus also always comprises certain amounts of oxidized phosphine, especially preferably triphenylphosphine oxide.

It is preferable when the amount of phosphine stabilizer in the end product is >0.01 wt %, more preferably >0.02 wt %.

It is yet more preferable when the compositions according to the invention comprise 0.03 to 0.500 wt %, more preferably 0.04 to 0.07 wt %, of phosphine.

Obtainable phosphite stabilizers that are suitable in the context of the present invention are, for example, Irgafos® 168 (tris(2,4-di-tert-butylphenyl) phosphite/CAS No. 31570-04-4), Irgafos® TPP (CAS No. 101-02-0), ADK PEP Stab 36 (CAS No. 80693-00-1), Hostanox® P-EPQ (CAS No. 119345-01-6) and Irgafos® TNPP (CAS No. 26523-78-4), particular preference being given to Irgafos® 168.

The group of antioxidants especially includes sterically hindered phenols. Possible sterically hindered phenols are, for example, esters n-octadecyl 3-(3,5-di-t-butyl-4-hydroxyphenyl)propionate or B-(5-tert-butyl-4-hydroxy-3-methylphenyl)propionic acid or 13-(3,5-dicyclohexyl-4-hydroxyphenyl)propionic acid with mono- or polyhydric alcohols, for example with methanol, ethanol, butanol, n-octanol, i-octanol, n-octadecanol. 1,6-hexanediol, 1,9-nonanediol, ethylene glycol, 1,2-propanediol, neopentyl glycol, diethylene glycol, triethylene glycol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

It is particularly preferable to employ the sterically hindered phenol n-octadecyl 3-(3,5-di-t-butyl-4-hydroxyphenyl)propionate. The sterically hindered phenol is preferably used in amounts of 0.01 to 0.1 wt %, preferably 0.015 to 0.06 wt %, based on the total weight of the composition.

Commercially available suitable phenolic antioxidants are, for example, Irganox® 1076 (CAS No. 2082-79-3/2,6-di-tert-butyl-4-(octadecanoxycarbonylethyl)phenol) and Irganox® 1010 (CAS No. 6683-19-8).

The stabilizer combination preferably comprises

a) 10 wt %-89 wt %, more preferably 20 wt %-78 wt % and particularly preferably 30 wt %-67 wt % of at least one phosphine stabilizer,

b) 10 wt %-89 wt %, more preferably 20 wt %-78 wt % and particularly preferably 30 wt %-67 wt % of at least one phosphite stabilizer, and

c) 1 wt %-50 wt %, more preferably 2 wt %-40 wt % and particularly preferably 3 wt %-20 wt % of at least one phenolic antioxidant,

wherein the components a)-c) sum to 100% by weight.

In a particularly preferred embodiment the stabilizer combination consists of triphenylphosphine, Irganox 1076® and bis(2,6-di-t-butyl-4-methylphenyl)pentaerythrityl diphosphite.

Irganox® 1010 (pentaerythritol 3-(4-hydroxy-3,5-di-tert-butylphenyl)propionate; CAS No. 6683-19-8) may be used as an alternative to Irganox® 1076.

The proportion of the stabilizer combination in the overall composition is 0.001 wt %-0.500 wt %, preferably 0.005 wt %-0.300 wt %, more preferably 0.05 to 0.270 wt %, particularly preferably 0.15 wt %-0.25 wt %, based on the total weight of the composition.

In a preferred embodiment the ratio of phosphite stabilizer to phenolic antioxidant is 1:5 to 10:1, more preferably 1:5 to 5:1 and particularly preferably from 3:1 to 4:1.

In a more preferred embodiment the ratio of phosphine (a) to the mixture of phosphite and phenolic antioxidant (b+c) is preferably 8:1 to 1:9, more preferably 1:5 to 5:1, wherein the ratio of phosphite stabilizer (b) to phenolic antioxidant (c) is from 1:5 to 10:1, more preferably from 1:5 to 5:1 and particularly preferably from 3:1 to 4:1.

Further phosphorus-based stabilizers or other thermal stabilizers may be employed to stabilize the thermoplastic matrix provided these do not adversely affect the stabilization described above.

Component E

The compositions comprising aromatic polycarbonate may also be admixed with one or more of the additives customary for polycarbonate compositions, such as flame retardants, anti-drip agents, impact modifiers, fillers, antistats, colorants, including pigments distinct from component B, also comprising carbon black, lubricants and/or demolding agents, UV absorbers, IR absorbers, hydrolysis stabilizers and/or compatibilizers. The group of further additives comprises no pigments of component B, i.e. any pearlescent pigments and/or interference pigments from the group of metal oxide-coated micas, or any epoxy-containing copolymers or terpolymers of styrene and acrylic acid and/or methacrylic acid, since these are designated as component C. The group of further additives of component E additionally comprises no thermal stabilizers, since these are already covered by the component D present.

The amount of further additives is preferably up to 10 wt %, more preferably up to 7 wt %, yet more preferably up to 5 wt %, particularly preferably 0.01 wt % to 3 wt %, very particularly preferably up to 1 wt %, based on the overall composition.

Particularly suitable demolding agents for the compositions according to the invention are pentaerythritol tetrastearate (PETS) or glycerol monostearate (GMS), carbonates thereof and/or mixtures of these demolding agents.

Colorants including pigments in the context of the present invention of component E are, for example, sulfur-containing pigments such as cadmium red and cadmium yellow, iron cyanide-based pigments such as Prussian blue, oxide pigments such as titanium dioxide, zinc oxide, red iron oxide, black iron oxide, chromium oxide, titanium yellow, zinc/iron-based brown, titanium/cobalt-based green, cobalt blue, copper/chromium-based black and copper/iron-based black or chromium-based pigments such as chromium yellow, phthalocyanine-derived dyes such as copper phthalocyanine blue and copper phthalocyanine green, fused polycyclic dyes and pigments such as azo-based (e.g. nickel azo yellow), sulfur indigo dyes, perinone-based, perylene-based, quinacridone-derived, dioxazine-based, isoindolinone-based and quinophthalone-derived derivatives, anthraquinone-based heterocyclic systems, but in any case no pearlescent pigments and/or interference pigments from the group of the metal oxide-coated micas.

Specific examples of commercial products are, for example, MACROLEX® Blue RR, MACROLEX® Violet 3R, MACROLEX® EG, MACROLEX® Violet B (Lanxess AG, Germany), Sumiplast® Violet RR, Sumiplast® Violet B, Sumiplast® Blue OR, (Sumitomo Chemical Co., Ltd.), Diaresin® Violet D, Diaresin® Blue G, Diaresin® Blue N (Mitsubishi Chemical Corporation), Heliogen® Blue or Heliogen® Green (BASF AG, Germany).

Among these, preference is given to cyanine derivatives, quinoline derivatives, anthraquinone derivatives, phthalocyanine derivatives.

The employed carbon blacks are preferably nanoscale carbon blacks, more preferably nanoscale pigment blacks. These preferably have an average primary particle size, determined by scanning electron microscopy, of less than 100 nm, preferably of 10 to 99 nm, more preferably of 10 to 50 nm, particularly preferably of 10 to 30 nm, especially of 10 to 20 nm. The finely divided pigment blacks are particularly preferred.

Commercially available carbon blacks that are suitable in the context of the invention are obtainable in a multitude of trade names and forms, such as pellets or powders. For instance, suitable carbon blacks are available under the BLACK PEARLS® trade names, as wet-processed pellets under the ELFTEX®, REGAL® and CSX® names, and in a flaky form as MONARCH®, ELFTEX®,

REGAL® and MOGUL®, all from Cabot Corporation. Especially preferred are carbon blacks that are traded under the BLACK PEARLS® trade name (CAS No. 1333-86-4).

The composition optionally comprises an ultraviolet absorber. Suitable ultraviolet absorbers are compounds having the lowest possible transmittance below 400 nm and the highest possible transmittance above 400 nm. Such compounds and the preparation thereof are known from the literature and are described, for example, in EP 0 839 623 A1, WO 1996/15102 A2 and EP 0 500 496 A1. Ultraviolet absorbers particularly suitable for use in the composition according to the invention are benzotriazoles, triazines, benzophenones and/or arylated cyanoacrylates.

The following ultraviolet absorbers are suitable for example: hydroxybenzotriazoles, such as 2-(3′,5′-bis(1,1-dimethylbenzyl)-2′-hydroxyphenyl)benzotriazole (Tinuvin® 234, BASF SE, Ludwigshafen), 2-(2′-hydroxy-5′-(tert-octyl)phenyl)benzotriazole (Tinuvin® 329, BASF SE, Ludwigshafen), 2-(2′-hydroxy-3′-(2-butyl)-5′-(tert-butyl)phenyl)benzotriazole (Tinuvin® 350, BASF SE, Ludwigshafen), bis(3-(2H-benzotriazolyl)-2-hydroxy-5-tert-octyl)methane, (Tinuvin® 360, BASF SE, Ludwigshafen), (2-(4,6-diphenyl-1,3,5-triazin-2-yl)-5-(hexyloxy)phenol (Tinuvin® 1577, BASF SE, Ludwigshafen), the benzophenones 2,4-dihydroxybenzophenone (Chimasorb® 22, BASF SE, Ludwigshafen) or 2-hydroxy-4-(octyloxy)benzophenone (Chimassorb® 81, BASF SE, Ludwigshafen), 2-cyano-3,3-diphenyl-2-propenoic acid, 2,2-bis[[(2-cyano-1-oxo-3,3-diphenyl-2-propenyl)oxy]methyl]-1,3-propanediyl ester (9CI) (Uvinul® 3030, BASF SE, Ludwigshafen), 2-[2-hydroxy-4-(2-ethylhexyl)oxy]phenyl-4,6-di(4-phenyl)phenyl-1,3,5-triazine (CGX UVA 006, BASF SE, Ludwigshafen) or tetraethyl 2,2′-(1,4-phenylenedimethylidene)bismalonate (Hostavin® B-Cap, Clariant AG). It is also possible to use mixtures of these ultraviolet absorbers.

Suitable IR absorbers are disclosed, for example, in EP 1 559 743 A1, EP 1 865 027 A1, DE 10 022 037 A1 and DE 10 006 208 A1. Of the IR absorbers mentioned in the literature cited, preference is given to those based on boride and tungstate, especially cesium tungstate or zinc-doped cesium tungstate, and also ITO- and ATO-based absorbers and combinations thereof.

Impact modifiers present may be standard impact modifiers. This group comprises both core/shell-based systems such as ABS, MBS, acrylic-based, silicone/acrylic-based impact modifiers, but also non-core/shell-based impact modifiers.

Organic and inorganic fillers may be added to the polycarbonate composition in customary amounts. Suitable materials in principle include all finely ground organic and inorganic materials. These may have a particulate, flaky or fibrous character for example. Examples of these include chalk, quartz powder, titanium dioxide, silicates/aluminosilicates, for example talc, wollastonite, montmorillonite, especially also in an organophilic form modified by ion exchange, kaolin, zeolites, vermiculite, and also aluminum oxide, silica, magnesium hydroxide and aluminum hydroxide. It is also possible to use mixtures of different inorganic materials.

Preferred organic fillers are finely divided (nanoscale) inorganic compounds of one or more metals from the 1st to 5th main group and 1st to 8th transition group of the periodic table, preferably from the 2nd to 5th main group, particularly preferably from the 3rd to 5th main group, and the 4th to 8th transition group with the elements oxygen, sulfur, boron, phosphorus, carbon, nitrogen, hydrogen and/or silicon.

Preferred compounds are, for example, oxides, hydroxides, water-containing/basic oxides, sulfates, sulfites, sulfides, carbonates, carbides, nitrates, nitrites, nitrides, borates, silicates, phosphates and/or hydrides.

It is preferable to employ the anti-drip agent polytetrafluoroethylene (PTFE), especially in amounts of 0.2 to 0.8 wt %.

It will be appreciated that the employed components may comprise customary impurities arising from their production process for example. It is preferable to use the purest possible components. It will further be appreciated that these impurities may also be present in an exhaustive formulation of the composition.

Thermoplastic compositions particularly preferred according to the invention are those comprising
A) 90.0 wt % to 97.5 wt %, preferably 93.0 wt % to 97.5 wt %, of aromatic polycarbonate, preferably having an MVR of 5 to 20 cm³/(10 min), determined according to ISO 1133:2012-03 at a testing temperature of 300° C. with a load of 1.2 kg,
B) 1.0 to 2.5 wt %, preferably 1.2 to 2.0 wt %, of pearlescent pigment and/or interference pigment from the group of titanium dioxide-coated micas, particularly preferably comprising at least 98 wt % of anatase-coated mica,
C) 0.1 wt % to 2.0 wt %, particularly preferably 0.2 wt % to 1.2 wt %, of epoxy-containing copolymer or terpolymer of styrene and acrylic acid and/or methacrylic acid,
D) 0.001 wt % to 0.500 wt %, preferably 0.05 to 0.270 wt %, of one or more thermal stabilizers, wherein component D comprises phosphite as thermal stabilizer, preferably comprising
   i) phosphine, phosphite and phenolic antioxidant,
E) up to 7 wt %, preferably up to 5 wt %, particularly preferably 0.1 to 3 wt %, very particularly preferably up to 1 wt %, of further additives, most preferably selected from the group consisting of flame retardants, anti-drip agents, impact modifiers, fillers, antistats, colorants, including pigments distinct from component B, also comprising carbon black, lubricants and/or demolding agents, hydrolysis stabilizers, compatibilizers, UV absorbers and/or IR absorbers.

According to the invention the term “up to” in each case comprises the value that follows these words as the upper limit

The group of further additives of component E very particularly preferably consists solely of colorants, demolding agents, pigments distinct from component B, especially carbon black.

Thermoplastic compositions very particularly preferred according to the invention comprise

A) 90.0 wt % to 97.5 wt % of aromatic polycarbonate, preferably having an MVR of 5 to 12 cm³/(10 min), determined according to ISO 1133:2012-03 at a testing temperature of 300° C. with a load of 1.2 kg,

B) 1.2 to 2.0 wt %, preferably 1.5 to 2.0 wt %, of pearlescent and/or interference pigment from the group of metal oxide-coated mica,

C) 0.2 wt % to ≤1 wt %, particularly preferably 0.3 wt % to 0.8 wt %, of epoxy-containing copolymer or terpolymer of styrene and acrylic acid and/or methacrylic acid,

D) 0.05 wt % to 0.270 wt %, most preferably 0.10 wt % to 0.25 wt %, of one or more thermal stabilizers, wherein component D comprises one or more phosphites as thermal stabilizers, comprising, most preferably consisting of,
i) phosphine, phosphite and phenolic antioxidant,

E) up to 7 wt %, preferably up to 3 wt %, most preferably up to 1 wt %, of further additives, wherein the further additives are most preferably selected from the group consisting of colorants, lubricants, mold release agents, pigments distinct from component B, especially carbon black,

wherein component b is titanium dioxide-coated mica, most preferably comprising at least 98 wt % of anatase-coated mica.

The thermoplastic compositions most preferably comprise no further components.

The polymer compositions according to the invention which comprise the abovementioned components are produced by commonplace methods of incorporation, by combining, mixing and homogenizing the individual constituents, the homogenization in particular preferably taking place in the melt by application of shear forces. Combination and mixing is optionally effected prior to melt homogenization using powder pre-mixes.

It is also possible to use pre-mixes of pellet materials or pellet materials and powders with the additives according to the invention.

It is also possible to use pre-mixes produced from solutions of the mixture components in suitable solvents where homogenization is optionally effected in solution and the solvent is then removed.

In this case in particular, the components and aforementioned additives of the compositions according to the invention can be introduced by known processes or as a masterbatch.

The use of masterbatches is especially preferred for introduction of the additives, in which case masterbatches based on the respective polymer matrix in particular are used.

In this context, the composition can be combined, mixed, homogenized and then extruded in standard apparatuses such as screw extruders (for example twin-screw extruders (TSE)), kneaders or

Brabender or Banbury mills. After extrusion, the extrudate may be chilled and comminuted. It is also possible to premix individual components and then add the remaining starting materials individually and/or likewise in admixture.

The polymer moldings can be produced from the compositions according to the invention preferably by injection molding, extrusion or rapid heat cycle molding.

The compositions according to the invention are preferably used for the production of injection moldings, especially those having thin walls, with a pearlescent look. It is likewise preferable to use the compositions according to the invention for production of extrudates. According to the invention injection molded parts and extrudates are “moldings”.

“Thin-walled” moldings in the context of the present invention are those where at the thinnest points wall thicknesses of less than approximately 3 mm, preferably less than 3 mm, more preferably of less than 2.5 mm, yet more preferably of less than 1.5 mm, very particularly preferably of less than 0.5 mm, are present. In this context “approximately” is to be understood as meaning that the actual value does not deviate substantially from the recited value, where a deviation of not more than 25%, preferably not more than 10%, is deemed as “not substantial”. The invention therefore also provides corresponding moldings comprising or consisting of these compositions, referred to collectively as “moldings formed from these compositions”.

These polymer moldings consisting of or comprising the compositions according to the invention likewise form part of the subject-matter of the present invention.

### EXAMPLES

A: Makrolon® 3108 powder from Covestro Deutschland AG. Linear polycarbonate based on bisphenol A having a melt volume flow rate MVR of 6 cm³/(10 min) (according to ISO 1133:2012-03 at a testing temperature of 300° C. with a load of 1.2 kg). Tested with an automatic flow tester from Zwick Roell, Ulm.
B: Pearlescent pigment. Mearlin® Magnapearl® 3000 anatase-coated mica from BASF. The pearlescent pigment consisted of a mica coated with titanium dioxide. Muscovite was determined as the relevant mica mineral by X-ray powder diffractometry. The ratio of the two components was determined as 56% mica and 44% anatase. The D50 was determined as 5.7 μm using a Malvern Mastersizer.
C: Copolymer of styrene and 2,3-epoxypropylmethacrylate. Styrene proportion: 53% by weight, determined by ¹H-NMR spectroscopy in CDCl₃. M_{w}=7400 g/mol, determined by gel permeation chromatography in o-dichlorobenzene at 150° C. using polystyrene standards. The epoxy content, determined according to DIN EN 1877-1:2000, is 14% by weight.
D-1: ADK STAB® PEP-36, bis(2,6-di-t-butyl-4-methylphenyl)pentaerythritol diphosphite, available from Adeka Palmarole.
D-2: Hostanox PEPQ. Stabilizer mixture, comprising tetrakis(2,4-di-tert-butylphenyl)-4,4′-biphenyl diphosphonite as the main component, available from Clariant.
D-3: Irganox® 1076, n-octadecyl 3-(3,5-di-t-butyl-4-hydroxyphenyl)propionate, available from BASF SE.
D-4: Irganox® B900, mixture of four parts Irgafos® 168 and one part Irganox® 1076. Irgafos® 168: tris(2,4-tert-butylphenyl) phosphite, available from BASF SE.
D-5: triphenylphosphine, available from BASF SE.
E-1: pentaerythritol tetrastearate; Loxiol VPG 861 from Emery Oleochemicals.
E-2: Mixture of customary colorants including carbon black.

The polycarbonate compositions described in the following examples were produced by compounding on a Clextral Evolum EV32 extruder at a throughput of 50 kg/h. The melt temperature was 300° C.

Melt volume flow rate (MVR) was determined according to ISO 1133:2012-03 (at a testing temperature of 300° C., mass 1.2 kg) using a Zwick 4106 instrument from Zwick Roell.

TABLE 1
Compositions and MVR

| | 1V | 2V | 3V | 4V | 5V | 6E | 7E | 8V | 9V | 10V | 11V |
|---|---|---|---|---|---|---|---|---|---|---|---|
| | [% by | [% by | [% by | [% by | [% by | [% by | [% by | [% by | [% by | [% by | [% by |
| | wt.] | wt.] | wt.] | wt.] | wt.] | wt.] | wt.] | wt.] | wt.] | wt.] | wt.] |
| A | 97.48 | 97.38 | 97.28 | 97.38 | 97.28 | 97.18 | 96.98 | 97.38 | 97.28 | 97.48 | 97.48 |
| B | 1.94 | 1.94 | 1.94 | 1.94 | 1.94 | 1.94 | 1.94 | 1.94 | 1.94 | 1.94 | 1.94 |
| C | | | | | | 0.2 | 0.4 | | | | |
| D-1 | | 0.08 | 0.16 | | | 0.08 | 0.08 | | | | |
| D-2 | | | | 0.08 | 0.16 | | | | | | |
| D-3 | | 0.02 | 0.04 | 0.02 | 0.04 | 0.02 | 0.02 | | | | |
| D-4 | | | | | | | | 0.1 | 0.2 | | |
| D-5 | 0.05 | 0.05 | 0.05 | 0.05 | 0.05 | 0.05 | 0.05 | 0.05 | 0.05 | 0.05 | 0.05 |
| E-1 | 0.4 | 0.4 | 0.4 | 0.4 | 0.4 | 0.4 | 0.4 | 0.4 | 0.4 | 0.4 | 0.4 |
| E-2 | 0.13 | 0.13 | 0.13 | 0.13 | 0.13 | 0.13 | 0.13 | 0.13 | 0.13 | 0.13 | 0.13 |
| MVR | 12.74 | 11.57 | 9.72 | 12.64 | 12.09 | 7.1 | 6.8 | 12.57 | 14.21 | 11.78 | 17.83 |
| [cm³/(10 min)] | | | | | | | | | | | |

1.-13. (canceled)

14. A thermoplastic composition comprising
A) 50 wt % to 98.5 wt % of aromatic polycarbonate and
B) 0.8 wt % to ≤5.0 wt % of interference pigment and/or pearlescent pigment from the group of metal oxide-coated micas,
C) 0.05 wt % to ≤3 wt % of an epoxy-containing copolymer or terpolymer of styrene and acrylic acid and/or methacrylic acid, and
D) 0.001 wt % to 0.500 wt % of one or more thermal stabilizers, wherein component D comprises one or more phosphites as thermal stabilizers.

15. The thermoplastic composition as claimed in claim 14 comprising
A) 90.0 wt % to 97.5 wt % of aromatic polycarbonate,
B) 1.0 to ≤3.0 wt % of interference pigment and/or pearlescent pigment from the group of metal oxide-coated micas,
C) 0.2 wt % to ≤1 wt % of an epoxy-containing copolymer or terpolymer of styrene and acrylic acid and/or methacrylic acid,
D) 0.001 wt % to 0.500 wt % of one or more thermal stabilizers, wherein component D comprises one or more phosphites as thermal stabilizers.

16. The thermoplastic composition as claimed in claim 14, comprising 1.2 to 2.0 wt % of interference pigment and/or pearlescent pigment from the group of metal oxide-coated micas.

17. The thermoplastic composition as claimed in claim 14, wherein component D comprises
i) phosphine, phosphite and phenolic antioxidant,
as phosphorus-containing thermal stabilizers.

18. The thermoplastic composition as claimed in claim 14, wherein the thermal stabilizer bis(2,6-di-t-butyl-4-methylphenyl)pentaerythritoldiphosphite is present.

19. The thermoplastic composition as claimed in claim 14, wherein the epoxy-containing copolymer or terpolymer of styrene and acrylic acid and/or methacrylic acid comprises a copolymer of styrene and 2,3-epoxypropyl methacrylate.

20. The thermoplastic composition as claimed in claim 14, wherein component C is a copolymer of styrene and 2,3-epoxypropyl methacrylate.

21. The thermoplastic composition as claimed in claim 20, wherein component C has a styrene content, determined by ¹H-NMR spectroscopy in CDCl₃, of 30 to 70 wt %, a weight-average molar mass, determined by gel permeation chromatography in o-dichlorobenzene at 150° C. using polystyrene standards, of 2000 to 25000 g/mol and an epoxy proportion, determined according to DIN EN 1877-1:2000, of 5 to 20 wt %.

22. The thermoplastic composition as claimed in claim 14, wherein anatase- or rutile-coated mica is present as pearlescent and/or interference pigment from the group of metal oxide-coated micas.

23. The thermoplastic composition as claimed in claim 14, wherein the composition comprises
A) 90.0 wt % to 97.5 wt % of aromatic polycarbonate,
B) 1.2 wt % to 2.0 wt % of pearlescent pigment and/or interference pigment from the group of metal oxide-coated micas,
C) 0.1 wt % to ≤1 wt % of an epoxy-containing copolymer or terpolymer of styrene and acrylic acid and/or methacrylic acid,
D) 0.001 wt % to 0.500 wt % of one or more thermal stabilizers, wherein component D comprises one or more phosphites as thermal stabilizers,
E) 0 to 7 wt % of further additives selected from the group consisting of flame retardants, anti-drip agents, impact modifiers, fillers, antistats, colorants, including pigments distinct from component B, also comprising carbon black, lubricants, demolding agents, hydrolysis stabilizers, compatibilizers, UV absorbers and/or IR absorbers,
wherein component B is a pearlescent and/or interference pigment from the group comprising titanium dioxide-coated mica and the polymer of component C is a copolymer of styrene and 2,3-epoxypropyl methacrylate.

24. The thermoplastic composition as claimed in claim 23, wherein the composition comprises no further components.

25. The thermoplastic composition as claimed in claim 23, wherein optionally present further additives of component E comprise only colorants, demolding agents, and/or pigments distinct from component B.

26. A molding produced from a thermoplastic composition as claimed in claim 14.
